(19) United States
(12) Patent Application Publication
(10) Pub. No.: US 2007/0044627 A1
(43) Pub. Date: Mar. 1, 2007

(54) Speed and stroke control method and apparatus for a product table of a food slicer

(76) Inventors: Todd L. Clem, Goshen, IN (US); Scott M. Zeeb, Chicago, IL (US); Todd M. Squires, Bull Valley, IL (US)

Correspondence Address: Mark W. Croll;Illinois Tool Works Inc., 3600 West Lake Avenue, Glenview, IL, 60026, US

(21) Appl. No.: 11/348,565

(22) Filed: Feb. 7, 2006

Related U.S. Application Data
(60) Provisional application No. 60/711,771, filed on Aug. 26, 2005.

(51) Int. Cl. B26D 1/143

(52) U.S. Cl. 83/717; 83/932

(57) ABSTRACT

A food slicer is provided having a support member including a base portion and an upstanding portion integrally formed with the base portion. The upstanding portion includes a rotating cutting blade secured thereto for slicing food product and a first motor positioned within the upstanding portion for rotating the cutting blade. The base portion includes a food product table slidably secured thereto and is movable across the cutting blade for holding product while it is being sliced by the cutting blade. A second motor positioned within the upstanding portion is included for providing movement of the food product table with respect to the cutting blade. An adjustable gage plate also is provided for determining the thickness of a food product to be sliced by the cutting blade. A first control member accessible by an operator is included for controlling the length of the stroke of the food product table with respect to the cutting blade, and a second control member accessible by an operator also is included for controlling the speed of the food product table with respect to the cutting blade independent from the first control member.

### CROSS-REFERENCE TO RELATED APPLICATIONS

This application claims benefit of U.S. provisional patent application Ser. No. 60/711771, filed Aug. 26, 2005, which is herein incorporated by reference.

### TECHNICAL FIELD

The present invention relates generally to food slicers and more particularly to a method and apparatus for providing transition from manual mode to automatic mode for the food slicer that provides for an enhanced sanitary environment, enables easier operation and cleaning and incorporates a number of enhanced ergonomic features.

### BACKGROUND

The basic design of both manual and automatic food slicers has proven to be quite effective and durable throughout the years. Although various important improvements have been made to such slicers, the overall design has not changed very much particularly with regard to the overall cleanliness, ergonomics, or ease of operation.

Today, food slicers are utilized to slice a number of food products such as meats, cheeses and the like in a variety of environments such as delicatessens, supermarkets, and restaurants to name a few. Such food slicers need to be quite durable since they tend to be used for many hours during a day by many different individuals while providing the desired performance, safety and cleanliness.

Additionally, food slicers need to be designed to allow adaptability since they need to handle a variety of products of different shapes, sizes, and textures while readily providing slices of different thicknesses of the product being sliced. The speed at which a particular product is moved across the cutting blade can also vary on automatic food slicers to improve productivity.

Food slicers typically have a manual mode where an operator moves the product to be sliced across the slicing blade and an automatic mode where a motor provides for movement of the product table across the blade for slicing of food product. Such food slicers have some type of switch or the like that enables an operator to transition the food slicer from manual slicing mode to automatic slicing mode.

When transitioning from manual mode to automatic mode, the product table must first move from whatever position it was in prior to the transition to the “home” position which is at the front of the slicer. Once in the home position, the slicer then begins slicing at a predetermined or default stroke length and stroke speed.

### SUMMARY

In accordance with an embodiment, a food slicer is provided having a support member including a base portion and an upstanding portion integrally formed with the base portion. The upstanding portion includes a rotating cutting blade secured thereto for slicing food product and a first motor positioned within the upstanding portion for rotating the cutting blade.

The base portion includes a food product table slidably secured thereto and is movable across the cutting blade for holding product while it is being sliced by the cutting blade. A second motor is included positioned within the upstanding portion for providing movement of the food product table with respect to the cutting blade. An adjustable gage plate also is provided for determining the thickness of a food product to be sliced by the cutting blade.

A first control member accessible by an operator is included for controlling the length of the stroke of the food product table with respect to the cutting blade, and a second control member accessible by an operator also is included for controlling the speed of the food product table with respect to the cutting blade independent from the first control member.

### BRIEF DESCRIPTION OF THE DRAWINGS

The present disclosure will become better understood with reference to the following description and accompanying drawings, wherein:

FIG. 1 is a top right perspective view of a food slicer according to one embodiment of the present invention;

FIG. 2 is a front plan view of the food slicer of FIG. 1;

FIG. 3 is a bottom plan view of the food slicer of FIGS. 1 and 2;

FIG. 4 is a bottom plan view of the product table support arm of the food slicer of FIGS. 1-3 including the auto drive engagement mechanism in a disengaged position;

FIG. 5 is a to plan view of the product table support arm of the food slicer of FIGS. 1-3 including the auto drive engagement mechanism in a disengaged position;

FIG. 6 is an enlarged portion of FIG. 5 illustrating details of the drive belt engagement and the electrical switching mechanism in a disengaged position;

FIG. 7 is a bottom plan view of the product table support arm of the food slicer of FIGS. 1-3 including the auto drive engagement mechanism in an engaged position;

FIG. 8 is a to plan view of the product table support arm of the food slicer of FIGS. 1-3 including the auto drive engagement mechanism in an engaged position; and

FIG. 9 is an enlarged portion of FIG. 8 illustrating details of the drive belt engagement and the electrical switching mechanism in an engaged position; and

FIG. 10 is a perspective view of the auto drive motor and drive system of the food slicer.

### DETAILED DESCRIPTION

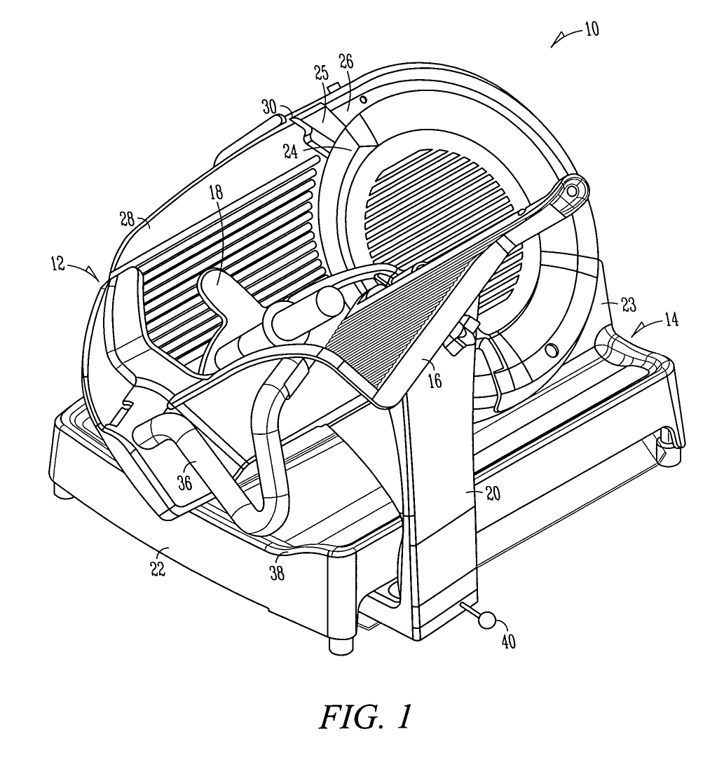

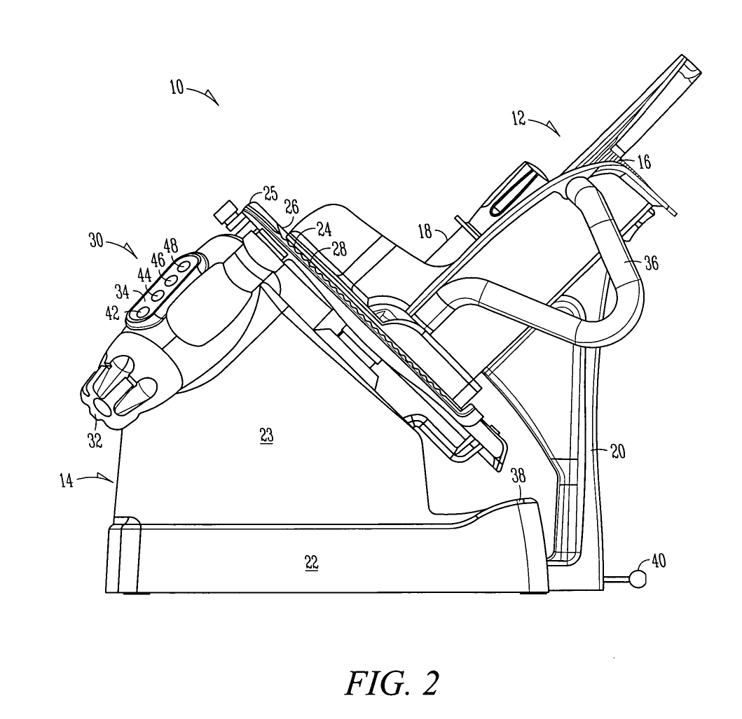

The food slicer of the present invention is generally illustrated by numeral 10 of FIGS. 1-2 wherein like parts are designated by like reference numerals. Although the present disclosure will be described with reference to the example embodiments illustrated in the figures, it should be understood that the food slicer 10 may have many alternative forms without departing from the teachings of the present invention. One of ordinary skill in the art will additionally appreciate different ways to alter the parameters of the embodiments disclosed, such as the size, shape, or type of elements or materials, in a manner that falls within the spirit and scope of the present disclosure and appended claims.

FIGS. 1 and 2 illustrate the basic components of the food slicer 10 of the present invention. The food slicer 10 substantially includes a food handling portion generally illustrated by reference numeral 12 and a support portion, housing or member generally illustrated by reference numeral 14.

The food handling portion 12 substantially includes a product table 16, a push arm or pusher 18 and a product table support arm 20. The support portion 14 substantially includes a base portion or member 22, an upstanding portion or member 23, a rotating circular slicing knife or cutting blade 24, a ring guard 25, a knife cover 26, an adjustable gage plate 28 for determining slicing thickness and a control member or operator interface 30 having a gage plate support and adjustment mechanism 32 for the gage plate 28 and control buttons 34 as illustrated in FIG. 2.

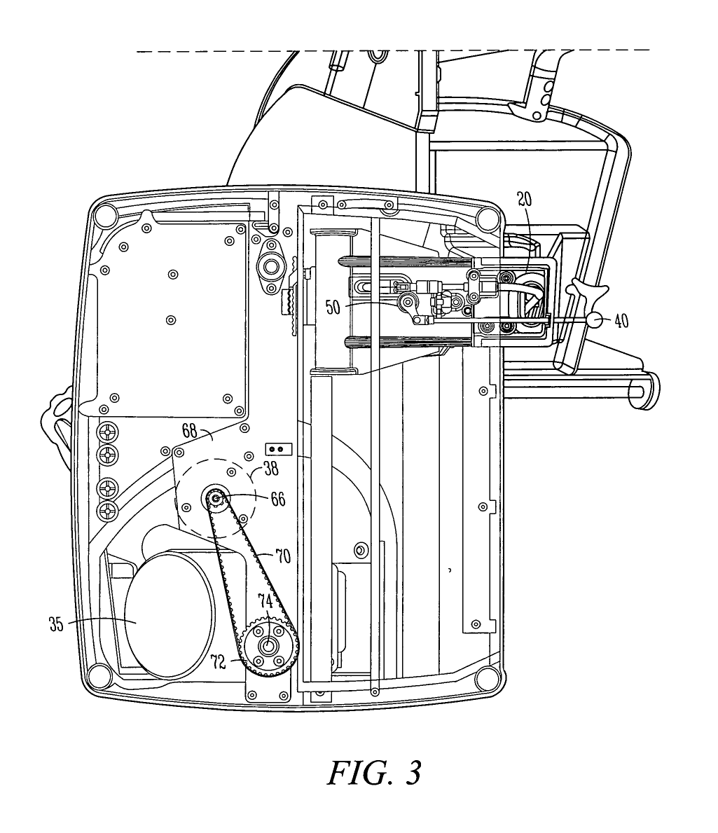

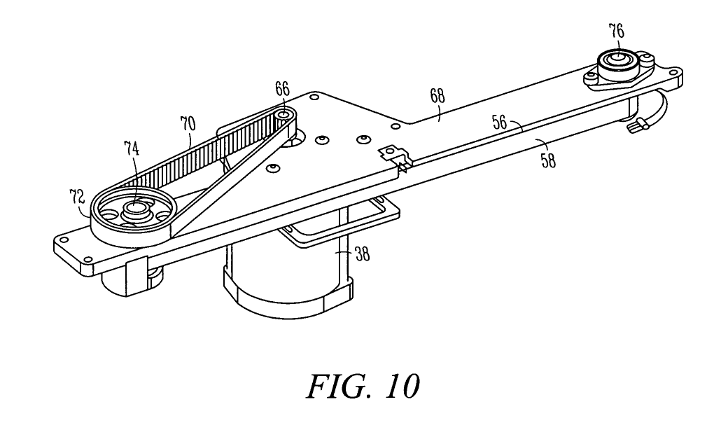

The support portion 14 also includes at least one motor 35 (FIG. 3) positioned within the inside of the upstanding portion 23. If desired, a second motor 38 (FIGS. 3 and 10) may be positioned within the inside of the support portion 14 along with associated structure for automatically moving the product table 16.

Briefly, for manual slicing, a food product (not illustrated) is placed on the product table 16 beneath the pusher 18 with the end to be cut or sliced resting upon the gage plate 28 with the product table 16 in its forward position. The operator adjusts the gage plate adjustment mechanism 32 which directly moves the gage plate 28 with respect to the blade 24 to provide a slice thickness gap therebetween that corresponds to the desired thickness for slicing of the product and gets bigger with thicker slices. The control buttons 34 are then accessed to turn the motor on which in turn rotates the blade 24.

The operator then pushes the product table 16 preferably via a handle 36 or other contact point forward or to the right with respect to FIG. 1 whereby the blade 24 slices the product to the desired thickness. The operator then pulls the product table 16 backward or to the left with respect to FIG. 1 for continued slicing of the product as described above.

For automatic slicing, after placing the food product in the product table 16 and adjusting the gage plate 28 to a desired thickness, an operator then actuates a knob, lever or button, such as lever 40 on the support arm 20. As described in detail below, by activating the lever 40 the slicer 10 is initially put into a “ready” mode till an “on” button is pressed to begin auto mode where the second motor 38 is activated to drive the product table 16 via the support arm 20 across the blade 24 at a particular length of stroke of the arm 20 and thus product table 16 with respect to the cutting blade 24 as well as a particular speed of travel of the product table 16 across the cutting blade 24. Once an operator transitions the food slicer 10 from manual mode to auto mode, the food slicer 10 slices food product on its own until the operator stops the slicing.

Typically, when an operator transitions the food slicer 10 from manual mode to auto mode the product table 16 is not in its fully forward or “home” position illustrated in FIG. 1. Accordingly, once the lever 40 is activated and the “on” button pressed the electronics of the food slicer 10 first engages the second motor 38 and then slowly moves the product table 16 from whatever position it may have been in to the home position where it can then begin slicing the food product.

Once in the home position, the electronics of the food slicer 10 automatically provide default settings for the stroke length or length of travel of the product table 16 with respect to the blade 24 as well as a particular speed of the product table 16 as it moves across the blade 24. Preferably, this default setting is full slicing stroke and slow speed, but can vary.

Once the slicer 10 is put in auto mode and the default stroke and speed settings are obtained, the operator frequently may want to adjust the stroke length, stroke speed or both depending on the size of the particular product being sliced in order to cut slices faster. This is particularly true when slicing food product having a smaller cross-section, such as a salami or pepperoni, for example. It is to be noted that the operator can do this “on the fly”, meaning he does not have to stop slicing to change the stroke length or speed of the product table 16.

As FIG. 2 illustrates, the operator interface 30 of the slicer 10 includes a number of control buttons generally illustrated by the reference numeral 34. More particularly, four controls buttons 42, 44, 46 and 48 are illustrated but the number can vary. Button 42 is an “on” button, button 44 is an “off” button, button 46 is a “speed control” button and button 48 is a “stroke control” button.

In one embodiment, since the default settings for auto mode are full stroke and slow speed the speed control button 46 increases the speed and the stroke control button 48 decreases the stroke of the product table 16 as it moves across the blade 24. Both the speed and stroke are increased and decreased by buttons 46 and 48 respectively in discrete incremental steps. Preferably three incremental steps are provided for each button 46 and 48 and when pressed in succession “scroll” over to the first setting. For example, the speed control button 46 starts at slow speed in the default setting. Pressing the button 46 once increases the speed to medium, pressing the button 46 a second time increases the speed to fast, pressing the button 46 a third time scrolls or cycles the speed back to slow. For the stroke button 48 the logic is the same except it decreases from full stroke, to medium stroke to short stroke and back to full stroke upon successively pressing the button 48. It is to be understood, however, that the particular number, shape and function of buttons 34 can vary.

Accordingly, once the slicer 10 is transitioned to auto mode, the operator can then access button 46 to increase the speed of the product table 16 in discrete increments as desired. Similarly, the operator can access button 48 to decrease the stroke of the product table 16 in discrete increments as desired. It is to be noted that the button 46 operates independently from button 48 so that an operator can fine tune the operation of the slicer 10 to accommodate a particular product depending on various characteristics of the product, including size, thickness, texture and ease of cutting.

For example, when slicing salami with a relatively small diameter to allow for faster slicing an operator typically will adjust the stroke of the product table 16 via button 48 to be shorter than the default setting of full stroke and just enough to cut the full diameter of the salami. An operator typically will also adjust the speed of the product table 16 via button 46 to be faster than the default setting of slow to enable faster cutting. By adjusting both the stroke and speed of the slicer 10 the salami is sliced faster.

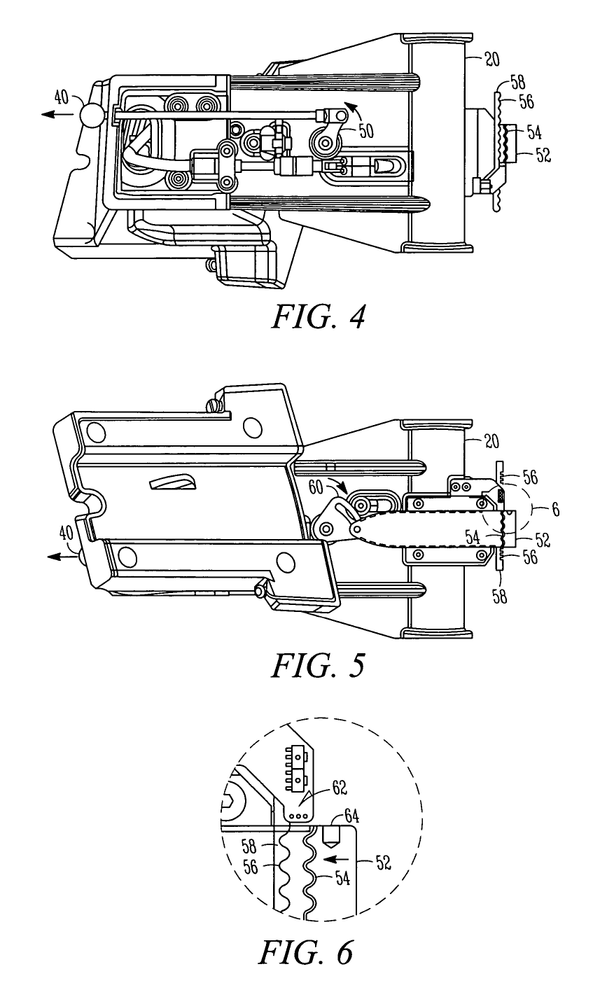

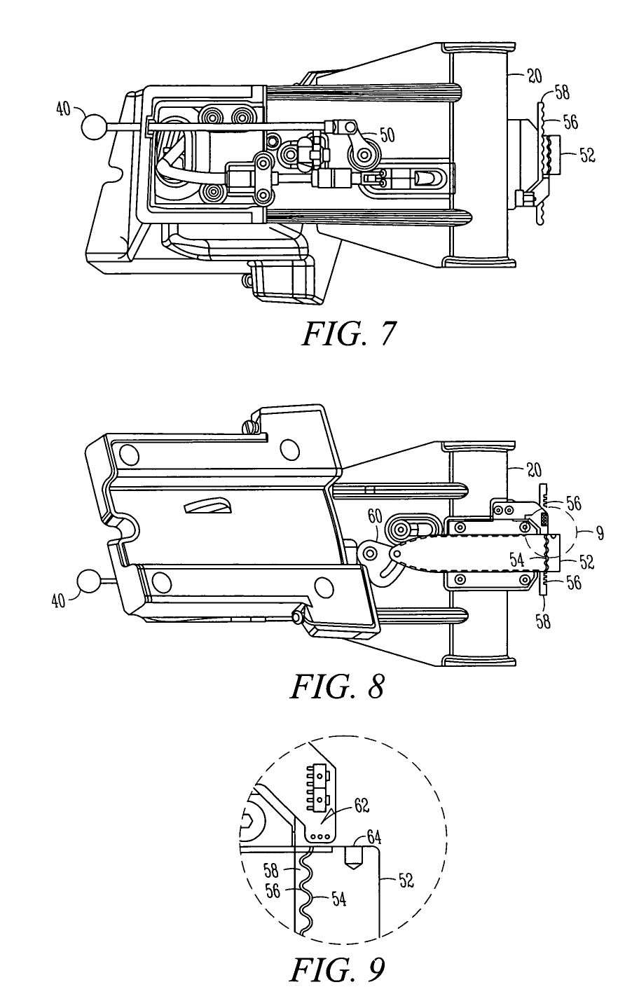

Briefly, referring to FIGS. 4 and 7, to transition the slicer 10 from manual to auto mode, after first turning off the blade 24 with off button 44, the lever 40 typically is pulled toward the left so the lever or knob 40 moves away from the exterior of the slicer 10. This movement of the lever 40 outward causes linkage 50 to rotate counterclockwise with respect to FIGS. 4 and 7. As the linkage 50 rotates, it pulls a clip 52 slightly to the left so that teeth 54 on the clip 52 can engage with teeth 56 on a drive belt 58 of the second motor 38 (FIGS. 3 and 10).

This motion of the linkage 50 and clip 52 also is illustrated in 5, 6, 8 and 9 with the rotation of the linkage 50 reversed since these figures are viewed from the top side of the support arm 20. Accordingly, movement of the lever 40 outward causes the linkage 50 to rotate clockwise to pull the clip 52 via cam 60 slightly to the left so that teeth 54 on the clip 52 can engage with teeth 56 on a drive belt 58 of the second motor 38. Of course, to disengage the auto drive the lever 40 is pushed inward thereby disengaging the teeth 54 on the clip 52 from the teeth 56 on the drive belt 58.

As FIGS. 6 and 7 illustrate, when the clip 52 moves to the left a first hall effect switch 62 aligns with permanent magnet 64 on the clip 52 to activate the electronics of the slicer 10 for auto drive and establish the desired default speed and stroke settings as described in more detail below.

As FIGS. 3 and 10 generally illustrate, the second motor 38 includes a shaft 66 and is secured to the slicer 10 by a bracket or plate 68. One end of a small drive belt 70 is attached to one end of the shaft 66 and the opposite end of the drive belt 70 is attached to a pulley 72. Pulley 72 has a shaft 74 that extends through the bracket 68 to the opposite side of the bracket 68 where it engages the larger drive belt 58 (FIG. 10). As described above, the teeth 56 on the inside surface of the belt 58 engage with the teeth 54 on the clip 52 (FIGS. 4-9) to attach the support arm 20 and the product table 16 to the belt 58 and enable the second motor 38 to drive the arm 20 and product table 16 via belts 70 and 58 for auto drive mode. At the end of the belt 58 opposite the pulley 72, a pully/tensioner assembly 76 can be included to secure the belt 58 for movement and enable tension adjustment if required.

The following is the sequence of events for transitioning the slicer 10 from manual to auto mode. With the blade 24 of the slicer 10 being either running or off, the lever 40 is pulled outward to engage the teeth 56 of the drive belt 58 with the teeth 54 of the clip 52 which is attached to the support arm 20 which may be in any position with respect to the slicer 10

Once the belt 58 is engaged with the clip 52, the first hall effect switch 62 is activated by the magnet 64 to a) verify auto mode, b) turn off the blade 24 and c) “wake up” the operator interface or control panel 30. In waking up the control panel 30, the speed button 46 and stroke button 48 light up and the default settings of slow speed and long stroke is set. Nothing happens, however, until the “on” button 42 is pressed which then starts the blade 24 turning.

If the support arm 20 is in its fully forward or “home” position, upon pressing the on button 42 a second hall effect switch and corresponding magnet (not illustrated) is activated and effectively “zeros” the electronics or tells the electronics that the arm 20 in fact is in the fully forward or home position. The slicer 10 then pauses momentarily and then ramps up to speed and starts to slice the food product and is monitored and controlled by an encoder described in more detail below. If the support arm 20 is not in the home position, the electronics will cause the arm 20 to slowly back up to its home position, trip the second hall effect switch to notify the electronics that the arm 20 is in the fully forward or home position and then pause and then ramp up to speed and thereafter controlled by the encoder described in more detail below.

Once the support arm 20 and product table 16 are moving to slice the product, the speed of the arm 20, stroke of the arm 20 or both can be changed “on the fly” in discrete increments by pressing buttons 46 or 48 respectively. In one embodiment, 3 settings are provided for both buttons 46 and 48 for a total of 9 possible speed and stroke combinations, although the number of combinations can vary which scroll back to the default settings as described above.

Once finished slicing, the operator presses off button 44. The slicer 10 then finishes its cut and returns to the home position. When the off button 44 is pressed, the lights for the speed and stroke buttons 46 and 48 will go off until the arm 20 returns to the home position. If the operator then restarts the slicer 10 by pressing the on button 42 without disengaging the lever 40, the slicer 10 will start auto slicing with the speed and stroke settings previously set by the operator, not the default settings.

If the lever 40 is pushed inward after slicing to disengage auto mode but the main power is not turned off to the slicer 10, the speed and stroke settings previously set by the operator will be stored in memory and the slicer 10 will go to those prior speed and stroke settings upon restart of the auto drive mode. It is to be understood, however, that the particular logic of the stroke, speed and other settings of the slicer 10 can vary.

Additionally, after the product table 16 is placed in the home position for auto slicing and the second hall effect switch is tripped, all subsequent positions of the product table 16 are accounted for by an encoder (not illustrated) in operable communication with an end (not illustrated) of the shaft 66 that extends to the exterior of the second motor 38 opposite the end of the shaft 66 that engages the belt 70. The encoder also can sense a full stroke and can adjust the stroke and/or speed of the slicer 10 to correct any errors short of a full stroke, among other functions. When the product table 16 approaches an end of its stroke, the electronics automatically decelerate the drive motor and thus the product table 16 in order to make a smooth transition to the opposite direction. This deceleration occurs regardless of the speed or stroke setting selected by the operator.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. It is intended that the present disclosure be limited only to the extent required by the appended claims and the applicable rules of law.

What is claimed is:

1. A food slicer, comprising:
a support member having a base portion and an upstanding portion integrally formed with said base portion;
a rotating cutting blade secured to said upstanding portion for slicing food product;
a first motor positioned within said upstanding portion for rotating said cutting blade;
a food product table slidably secured to said base portion and movable across said cutting blade for holding product while being sliced by said cutting blade;
a second motor positioned within said upstanding portion for providing movement of said food product table with respect to said cutting blade;
an adjustable gage plate for determining the thickness of a food product to be sliced by said cutting blade;
a first control member accessible by an operator for controlling the length of the stroke of said food product table with respect to said cutting blade, and
a second control member accessible by an operator for controlling the speed of said food product table with respect to said cutting blade independent from said first control member.

2. The food slicer as defined in claim 1, wherein at least one of said first and second control members provide discrete incremental increases and decreases of the respective stroke length and speed of said product table.

3. The food slicer as defined in claim 1, including a third control member accessible by an operator for reconfiguring the food slicer from a manual mode to an automatic mode.

4. A method of reconfiguring a food slicer from manual mode to automatic mode, comprising:
activating an engagement member for transitioning the slicer from manual to automatic mode;
providing electronics for starting movement of a product table of the slicer at a particular speed and stroke with respect to a cutting blade of the slicer;
activating a first control member to adjust the length of the stroke of the product table with respect to the cutting blade if desired; and
activating a second control member, independent from said first control member, to adjust the speed of the product table with respect to the cutting blade if desired.
